(19) United States
(12) Patent Application Publication
(10) Pub. No.: US 2020/0291183 A1
(43) Pub. Date: Sep. 17, 2020

(54) PROCESS FOR PREPARING POLYBENZIMIDAZOLES

(71) Applicant: Technische Universitaet Wien, Wien (AT)

(72) Inventors: Miriam Margarethe UNTERLASS, Wien (AT); Michael J. TAUBLAENDER, Wiesen (AT); Sophia THIELE, Wien (AT)

(21) Appl. No.: 16/649,261

(22) PCT Filed: Sep. 5, 2018
(86) PCT No.: PCT/EP2018/073891

§ 371 Date: Mar. 20, 2020

(30) Foreign Application Priority Data
Sep. 20, 2017 (AT) A 373/2017

(51) Int. Cl. C08G 73/18

(52) U.S. Cl. CPC C08G 73/18; C08G 2261/12; C08G 2261/314; C08G 2261/334

(57) ABSTRACT

The invention relates to a method for preparing polybenzimidazoles of formula (1) or (2) below, wherein n and m are each 1:

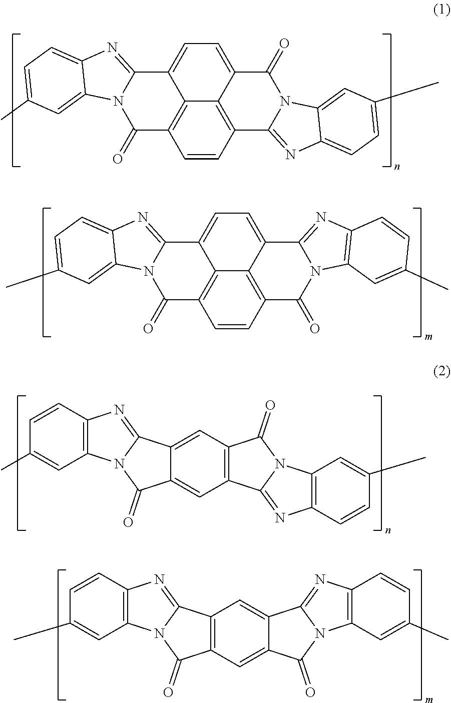

by polycondensation of corresponding tetracarboxylic acids or dianhydrides and tetraamines by jointly heating the reactants, characterized in that
the preparation of polybenzimidazoles of formula (1) or (2) is carried out by using tetracarboxylic acids as starting material and substantially without the formation of any by-products, wherein
a) first, a stoichiometric salt is formed from the tetracarboxylic acid and the tetraamine;
b) polycondensation is carried out under hydrothermal conditions by heating the stoichiometric salt obtained in step a), in water as a solvent and under pressure, to temperatures above 100° C.,
wherein the values of n and m and, thus, the molecular weight and/or the extent of cyclization in the polycondensate obtained, are/is regulated by means of the temperature and/or the duration of the polycondensation; and
c) optionally, a solvent-free thermal treatment of the polycondensate is carried out in order to achieve complete cyclization.

The present invention relates to a novel method for preparing polybenzimidazoles.

### PRIOR ART

Aromatic polybenzimidazoles, i.e. polymers having two benzimidazole moieties connected through an aromatic linker, thus forming a conjugated system, are valuable high-performance polymers due to their specific characteristics (high melting point, hardness, pressure resistance, light absorbance), e.g. for use in the fire protection field, for high-temperature membranes in polymer electrolyte fuel cells or in photo-voltaics. They are usually synthesized by polycondensation of aromatic tetraamines, more specifically bis(o-diamines), with aromatic dicarboxylic acids or carboxylic acids of higher valencies—or esters, anhydrides or aldehydes thereof—by heating the reactants to temperatures of more than 100° C. (when using high-boiling solvents) or up to several hundred degrees Celsius (in solid state). When using divalent carboxylic acids or aldehydes, this results in polymers, wherein each residue X of the respective carboxylic acid molecule or aldehyde molecule connects two imidazole rings of the polybenzimidazoles, as is shown below.

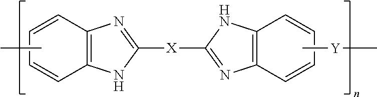

Depending on the choice of tetraamine, the benzene rings of the polybenzimidazoles are connected by a (preferably aromatic) linker Y which can also be a direct chemical bond such as the one obtained when using, e.g., tetraaminobiphenyl (diaminobenzidine, DAB) as tetraamine. The use of tetraaminobenzene constitutes a special case, as both imidazole rings are connected to the same benzene ring, as can be seen below.

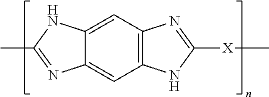

The synthesis of such polymers by use of aromatic dialdehydes is described in detail in an extensive review by Eberhard Neuse (Adv. Polym. Sci. 47, 1-42 (1982)) and, with special reference to diaminobenzidine as tetraamine, in another article of the same author (Neuse and Loonat, Macromolecules 16(1), 128-136 (1983)). According to these articles, mixing of tetraamine and dialdehyde already results in the formation of a polymer described as Schiff base, as is shown below for the case of a reaction of terephthalic acid dialdehyde and diaminobenzidine:

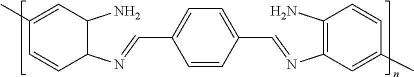

which subsequently is cyclized to obtain polybenzimidazole. Both articles make explicit reference to the necessity of eliminating oxygen when mixing the reactants as well as the presence of the same in the subsequent cyclization step. Otherwise, i.e. in the presence of 02 in the first polycondensation step, the result could be undesired oxidation reactions, whereas cyclization in absence of 02 is disclosed as “highly inefficient”, as it proceeds very slowly.

There is naturally far more literature on the synthesis of monomeric benzimidazoles, including hydrothermal syntheses, i.e. reactions in water as only or main solvent at temperatures above 100° C., which have become increasingly popular over the past years as they does not require the disposal of often highly toxic solvents. See for example Dudd et al., Green Chem. 5, 187-192 (2003), for the synthesis of 2-phenylbenzimidazole from diaminobenzene and benzoic acid in water at temperatures of up to 400° C., although temperatures below 350° C. did not result in a yield of more than 50% and yields of more than 90% were only obtained after 14 hours, and Nagao et al., Green Chem. 18, 3494-3498 (2016), for the synthesis of 1,2-diphenylbenzimidazole from 2-aminodiphenylamine and benzoic acid anhydride at temperatures between 400 and 445° C.

However, the use of tetravalent carboxyl or carbonyl compounds, e.g. of tetracarboxylic acids or anhydrides thereof, entails another cyclization step besides the cyclization of the imidazole ring. For example, when using benzene tetracarboxylic acid with tetraamino diphenyl ether, as disclosed by Bell and Pezdirtz, J. Polym. Sci. Pol. Lett. 3(12), 977-984 (1965), the first polycondensation is amidation by reacting an amino functionality each with a carboxylic acid functionality, which yields a so-called poly(amino-acid-amide) or “poly(A-A-A)”. Subsequently, the first cyclizations are to take place in the second condensation step: either through attacks on the free amino functionalities of previously amidated carboxyl carbons and simultaneously dehydration in order to form imidazoles fused to benzene rings of the tetraamine while maintaining free carboxyl groups, or through attacks of amide nitrogens on the free carboxyl carbons and simultaneously dehydration in order to form two imide moieties at the aromatic of the tetracarboxylic acid while maintaining free amino groups. The third and last condensation step are cyclizations, forming two 5-membered rings as is shown below. Strictly speaking, the intermediate with free amino groups shown on the right yields another one, i.e. the condensation product mirrored about a horizontal axis, as a polymer does not show free rotability of moieties. Bell and Pezdirtz point to this fact, too (“designation of the positions is arbitrary”).

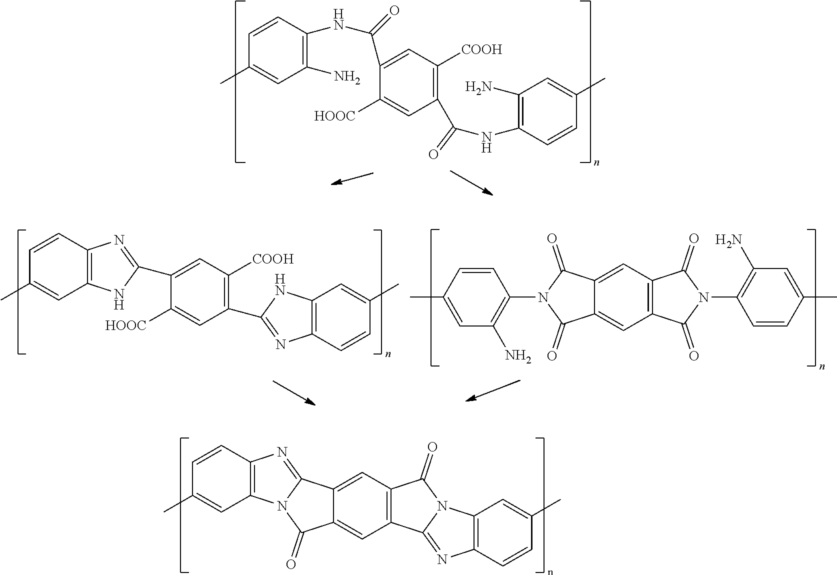

According to Bell and Pezdirtz, the polymeric A-A-A intermediates are isolated and used as a solution for coating surfaces, and it is only after heating to 325° C. that entirely condensed polybenzimidazoles are formed.

In literature, these polybenzimidazoles are also, amongst other names, called poly-imidazopyrrolones or, shorter, polypyrrones. See, for example, Dawans and Marvel, J. Polym. Sci., Part A: Polym. Chem. 3, 3549-3571 (1065), Bell and Jewell, J. Polym. Sci., Part A: Polym. Chem. 5, 3043-3060 (1967), and Johnston and Epps, J. Polym. Sci., Part A: Polym. Chem. 10, 2751-2765 (1972), which disclose syntheses starting from pyromellitic dianhydride, either in solid form at temperatures between 200 and 300° C., or as a solution in aprotic high-boiling solvents (e.g. dimethyl acetamide, DMAc).

Interestingly, V. L. Bell, who, in 1965, together with G. F. Pezdirtz had still considered both variants shown above for the formation of intermediates from the initial polycondensate “poly(A-A-A)” to be possible, disclosed only the right intermediate including free amino groups and cyclic imides, but no free carboxylic acid groups, two years later in Bell and Jewell (1967, supra).

The use of naphthalene tetracarboxylic acid instead of pyromellitic acid yields corresponding polybenzimidazoles having a saturated 6-membered ring. Due to their structural identity with the organic pigment and semiconductor perinone, they have, in recent years, also been called “polyperinones”. For synthesis, see for example Van Deusen, J. Polym. Sci. Pol. Lett. 4, 211-214 (1966), and Zhou and Lu, J. Appl. Polym. Sci. 58, 1561-1565 (1995). The latter discloses conducting the reaction in solution in DMAc, during which, initially, only the not cyclized intermediate is produced and isolated, and after subsequent film drawing using a DMAc solution thereof, is cyclized by heating to 300° C. Other authors also describe precipitation and isolation of the intermediate or filtration and centrifugation of its solution before the subsequent cyclization. Van Deusen (supra), however, discloses direct polycondensation resulting in an entirely cyclized polyperinone in polyphosphoric acid at temperatures of up to 220° C., which entails subsequent, often laborious cleaning of the polymers.

Morgan and Scott, J. Appl. Polym. Sci. 16, 2029-2050 (1972), disclose the preparation of stoichiometric mixtures and salts from tetracarboxylic acid and tetraamine, using N₂ as protective gas against the access of oxygen, as well as the subsequent polycondensation of the mixtures or salts, respectively, while simultaneously molding the polymer resulting therefrom by heat pressing while heating to temperatures of 450° C. This, however, yields products showing high fluctuations in quality and stability, even though higher stability was observed in nitrogen than in air.

All these polybenzimidazoles with fused 5- or 6-membered ring share the feature of cis- and trans-isomerisms with regards to the free carboxyl or amino groups of the intermediates and thus the carbonyl groups of the entirely condensed polymers, as Bell and Pezdirtz (supra) and Van Deusen (supra) indicate and as the inventors of the present application have confirmed. This will be elaborated further below.

The working group of the inventors has done elaborate research on hydrothermal syntheses for preparing polyimides in the past, see e.g. PCT/AT2016/050140 and PCT/AT2017/000058. More specifically, research has been done relating to polybenzimidazoles having fused 6-membered ring (“polyperinones”) mentioned above, see, for example, Michael Taubländer, “Development of Novel Synthetic Routes Towards Polyimides and Poly(perinone)s”, Diploma Thesis, Vienna University of Technology, 2017. In the course of this research it has been found that, generally, hydrothermal synthesis starting from naphthalene tetracarboxylic dianhydride (NTCADA) and diaminobenzidine (DAB) allows the preparation of the above-mentioned 6-membered polyperinones. However, the products showed very low molecular weights (determined by means of IR analysis) and the aqueous phases were highy contaminated and had a dark purple colour. This was attributed to a substantial proportion of oxidative polymerization generating various by-products which disturbed stoichiometry and thus prevented the yield of the desired polyperinone with high molecular weight. Furthermore, it proved difficult to separate these by-products from the target polymer, since, upon extraction, both aqueous and ethanolic washing solutions remained deeply coloured, even after many washings.

Against this backdrop, the objective of the present invention was to develop an improved method for preparing polybenzimidazoles, especially the above-mentioned polybenzimidazoles with fused 5- or 6-membered rings, which provides a relatively simple way of obtaining high-molecular polymers, without the formation of large amounts of hard-to-separate by-products.

### DISCLOSURE OF THE INVENTION

The present invention meets this objective by providing a method for preparing polybenzimidazoles of formula (1) or (2) below, wherein n and m are each ≥1:

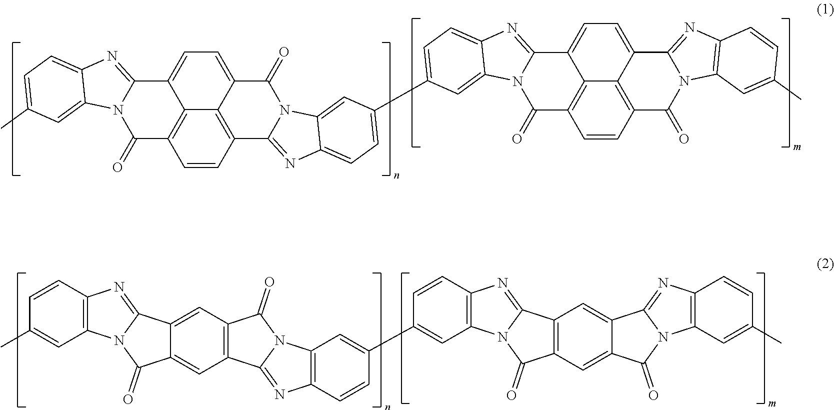

by polycondensation of corresponding tetracarboxylic acids or dianhydrides and tetraamines by jointly heating the reactants, characterized in that
the preparation of polybenzimidazoles of formula (1) or (2) is carried out by using tetracarboxylic acids as starting material and substantially without the formation of any by-products, wherein

a) first, a stoichiometric salt is formed from the tetracarboxylic acid and the tetraamine;

b) polycondensation is carried out under hydrothermal conditions by heating the stoichiometric salt obtained in step a), in water as a solvent and under pressure, to temperatures above 100° C.,

wherein the values of n and m and, thus, the molecular weight and/or the extent of cyclization in the polycondensate obtained, are/is regulated by means of the temperature and/or the duration of the polycondensation; and

c) optionally, a solvent-free thermal treatment of the polycondensate is carried out in order to achieve complete cyclization.

As opposed to earlier observations, the inventors surprisingly found that polycondensations carried out under hydrothermal conditions in order to give the above-mentioned polybenzimidazoles with fused 5- or 6-membered rings will indeed yield well-defined products if stoichiometric salts of the corresponding reactants, i.e. tetracarboxylic acid and tetraamine, are used as starting materials. Furthermore, preparation of these salts does not require a nitrogen atmosphere or any other protective gas atmosphere. This means that the acid and the amine may be mixed in an aqueous suspension and reacted under stirring to form the stoichiometric salt, although it is preferred to cool and degas the suspension first in order to be able to more reliably suppress possible oxidation reactions.

According to the present invention, polycondensation of the stoichiometric salt under hydrothermal conditions can be achieved in very short reaction times and, most surprisingly, without the formation of any by-products: All the aqueous phases obtained after completion of the polycondensation were clear. Furthermore, not even traces of impurities were detected upon extraction of the obtained polybenzimidazoles with a series of organic solvents, as the following working examples prove.

Just as surprising was the fact, found by the inventors, that the molecular weight of the polybenzimidazoles and the extent of cyclization in the respective polycondensate obtained can be controlled by means of reaction temperature and reaction time: depending on the respective reactants, increasing temperature and increasing reaction time yields polybenzimidazoles with increasing molecular weights and increasing extents of cyclization. This allows the preparation of defined polymers for different purposes—for example, by isolating and modifying not fully cyclized intermediates (similar to the way described in the state of the art section) at their free carboxyl or amino groups. These intermediates may subsequently be fully cyclized by means of a solvent-free thermal treatment.

However, another surprising fact that the inventors found by means of IR analysis was that hydrothermal synthesis of polybenzimidazoles of formula (2) according to the invention yielded almost exclusively intermediates having free carboxylic acid functionalities. By contrast, the inventors did not detect any intermediates at all in syntheses of polybenzimidazoles of formula (1). Without wishing to be bound by theory, the inventors therefore assume that hydrothermal conditions facilitate cyclization, giving the respective benzimidazole, as compared to the alternative imidation reaction.

In preferred embodiments of the present invention, a polybenzimidazole of formula (1) is prepared according to the reaction scheme below, wherein
in step a) naphthalene tetracarboxylic acid (NTCA) is reacted with diaminobenzidine (DAB) to form the stoichiometric salt NTCA.DAB, which
in step b), is polycondensed under hydrothermal conditions to form the polybenzimidazole of formula (1):

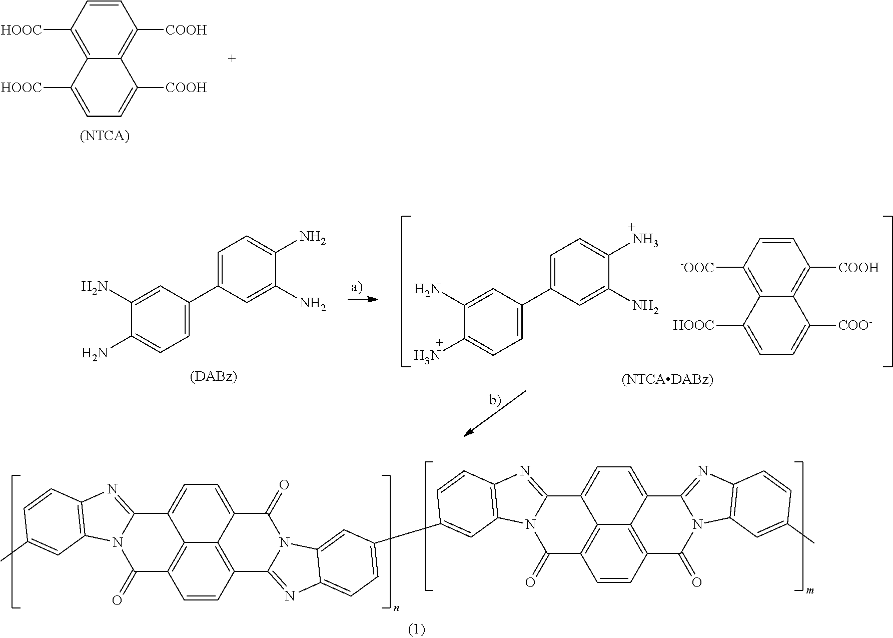

For an enlarged view of this reaction scheme see FIG. 1.

As mentioned above, such “polyperinones”—as well as not fully cyclized intermediates—show cis-trans isomerisms, which is why the oxygens of both amide carboxyl groups in the end products may point in opposing directions or in the same direction, as is illustrated in formulae (1) and (2) by the different moieties which are present n times or m times, respectively. Strictly speaking, there is a third alternative of the moieties in which both oxygen atoms do not point down, but up. For the sake of clarity, this description refrains from an explicit illustration of this alternative. The proportion between these moieties cannot be determined explicitly and, due to their identical chemical characteristics, is not essential for the characteristics of the polymers obtained, which is why this will not be elaborated further herein.

Without wishing to be bound by theory, the inventors found that, in the above reaction to form polybenzimidazoles of formula (1), in those cases where a 6-membered ring is formed between the imidazole and the central naphthalene, the two cyclization condensations seem to be facilitated as compared to the polycondensation to “A-A-A” polymers, so that the latter reaction is the rate-determining step. As a consequence, the molecular weights of the polybenzimidazoles obtained in these syntheses can be regulated by means of reaction temperature and reaction time.

In case polycondensation in step b) is carried out at a temperature of not more than 250° C. and/or for a duration of not more than 1 h, a polybenzimidazole (1) having a relatively low molecular weight is obtained. In case polycondensation is carried out at a temperature of not more than 300° C. and/or for a duration of not more than 2 h, a polybenzimidazole (1) having an average molecular weight is obtained; and in case it is carried out at a temperature of more than 300° C. and/or for a duration of at least 2 h, a polybenzimidazole (1) having a relatively high molecular weight is obtained, as can be determined by means of IR analyses and a comparison of the intensities of the bands of reactive terminal anhydride groups with those of the respective end product.

In alternative preferred embodiments of the invention, a polybenzimidazole of formula (2) is prepared according to the reaction scheme below, wherein
in step a), pyromellitic acid (PMA) is reacted with diaminobenzidine (DAB) to form the stoichiometric salt PMA.DAB which
in step b), is polycondensed under hydrothermal conditions to form a non-cyclized or partially cyclized intermediate (3) and/or the polybenzimidazole of formula (2):

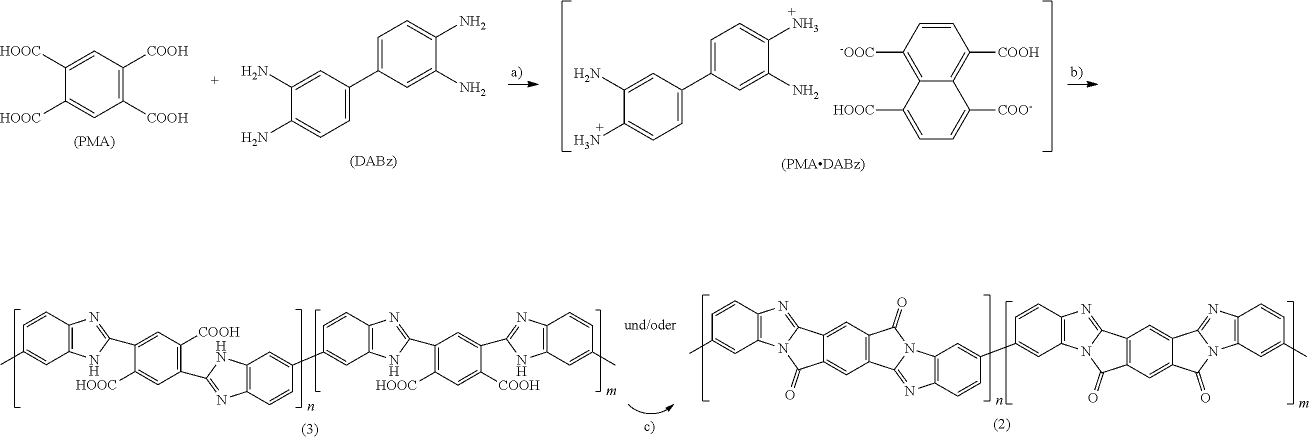

whereafter step c) is optionally conducted in order to convert intermediate (3) completely into the polybenzimidazole of formula (2).

For an enlarged view of the above reaction scheme see FIG. 2.

As opposed to the previously described syntheses to obtain polybenzimidazoles of formula (1), in these polycondensations forming 5-membered rings fused to imidazoles in polybenzimidazoles of formula (2), not propagation, but cyclization of intermediates still containing free carboxyl functionalities seems to be the rate-determining step, which means that, under hydrothermal conditions, condensation of the fused rings will not occur before complete propagation has occurred. This is why, according to the present invention, the extent of cyclization can be regulated by means of reaction temperature and/or reaction time.

In case polycondensation in step b) is carried out at a temperature of not more than 250° C. and/or for a duration of not more than 1 h, it substantially produces only the intermediate (3) which is cyclized to form the polybenzimidazole (2) in the subsequent step c). In case polycondensation is carried out at a temperature of not more than 275° C. and/or for a duration of not more than 2 h, a mixture of polybenzimidazole (2) and intermediate (3) is produced which is fully cyclized to form the polybenzimidazole (2) in the subsequent step c). If, however, polycondensation is carried out at a temperature of at least 350° C. and/or for a duration of at least 2 h, substantially only the polybenzimidazole (2) is produced.

The conditions of the optional solvent-free thermal treatment in step c) are not specifically limited, as long as a fully cyclized polybenzimidazole is obtained each. However, it is preferably carried out at a temperature of at least 200° C., more preferably at least 300° C. and most preferably at about 400° C., in order to achieve completion in a short time.

The present invention is herein described by means of unsubstituted reactants and illustrated by means of examples, nevertheless it is clear to a person skilled in the art that both the tetracarboxylic acid and the tetraamine may be substituted in a conventional manner without departing from the spirit of the invention, as long as the nature and position of the substituents do not interfere with or even take part in the polycondensation reactions, i.e. chain propagation, and the cyclization condensation reactions, which, for example, might occur in the case of bulky substituents or amino, carbonyl or carboxyl substituents. Instead of benzene or naphthalene tetracarboxylic acid, phenanthrene or another tetracarboxylic acid may be used as long as the position of the four carboxyl groups allow for corresponding cyclizations to form 5- or 6-membered rings fused to the imidazole ring. The same holds true in an analogous manner for the tetraamine, so that, for example, tetraamino benzophenone, tetraamino naphthalene, tetraamino diphenyl ether or similar tetraamines may be used instead of diaminobenzidine. Therefore, for example, substitutable hydrogen atoms at any positions of the aromatic ring systems may be substituted by non-interfering substituents such as halogen, lower alkyl or lower alkoxy, but also by any other groups disclosed in literature as non-interfering with such condensations.

### SHORT DESCRIPTION OF THE DRAWINGS

In the following, the present invention will be described in more detail by means of nonlimiting examples and with reference to the appended drawings, which show the following:

FIG. 1 is an enlarged view of the reaction scheme for the preparation of polybenzimidazoles of formula (1);

FIG. 2 is an enlarged view of the reaction scheme for the preparation of polybenzimidazoles of formula (2);

FIGS. 3 and 4 show the IR and ¹H NMR spectra of the stoichiometric salt prepared in Example 1;

FIGS. 5 to 7 show the IR spectra of the polybenzimidazoles of formula (1) prepared in Examples 2, 4 and 5;

FIGS. 8 and 9 show the IR and ¹H NMR spectra of the stoichiometric salt prepared in Example 7; and

FIGS. 10 and 11 show the IR spectra of the polybenzimidazoles of formula (2) prepared in Examples 8, 4 and 9.

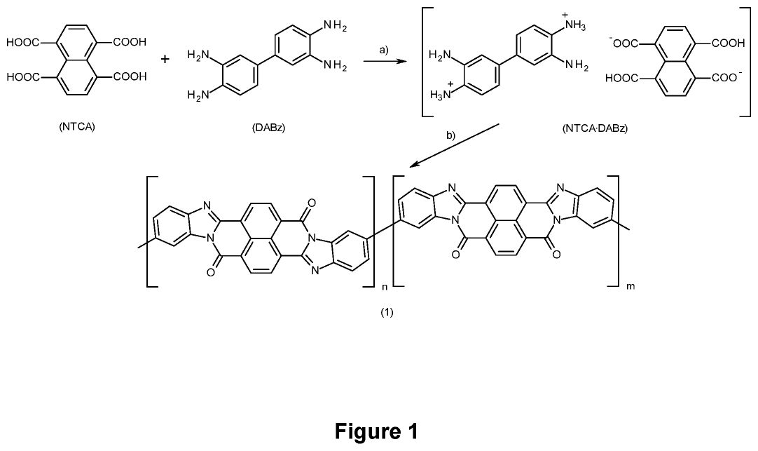

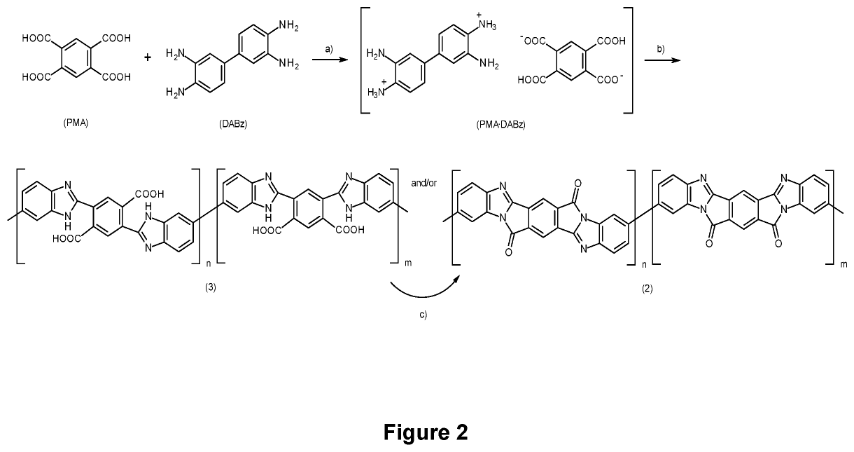

### EXAMPLES

### Synthesis Example 1

### Preparation of 1,4,5,8-naphthalene tetracarboxylic acid (NTCA)

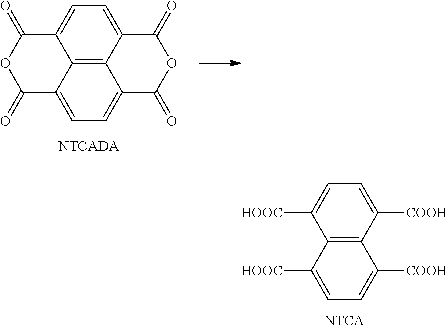

For hydrolyzing of the commercially purchased anhydride to give the acid, 1.0057 g of naphthalene tetracarboxylic acid dianhydride (NTCADA) (3.75 mmol, 1 eq.) were dissolved in 50 ml 1 M NaOH while stirring at room temperature. The clear solution was then cooled in an ice bath and concentrated HCl was added dropwise until reaching pH 1. During acidification, naphthalene tetracarboxylic acid (NTCA) precipitated as a white solid which was isolated by centrifugation, but not dried in order to avoid another cyclization to give the anhydride.

### Example 1—Step a) of the Method According to the Invention

### Preparation of a monomer salt from NTCA and 3,3′-diaminobenzidine

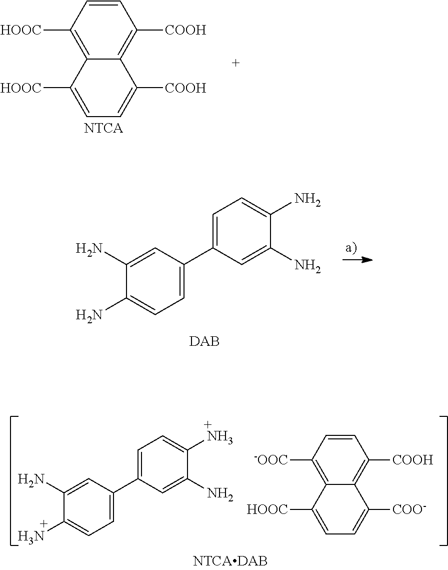

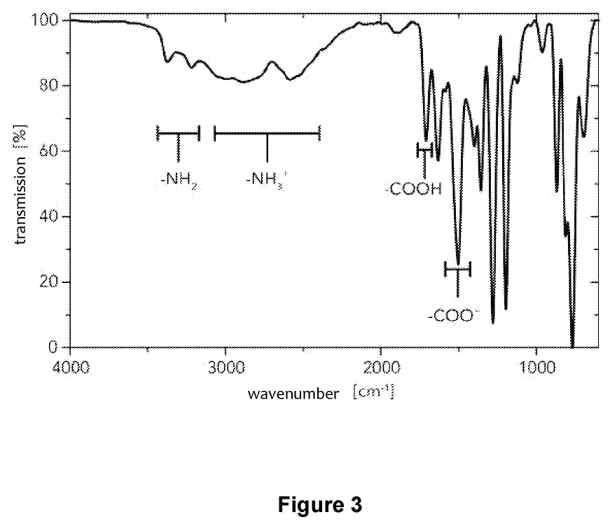

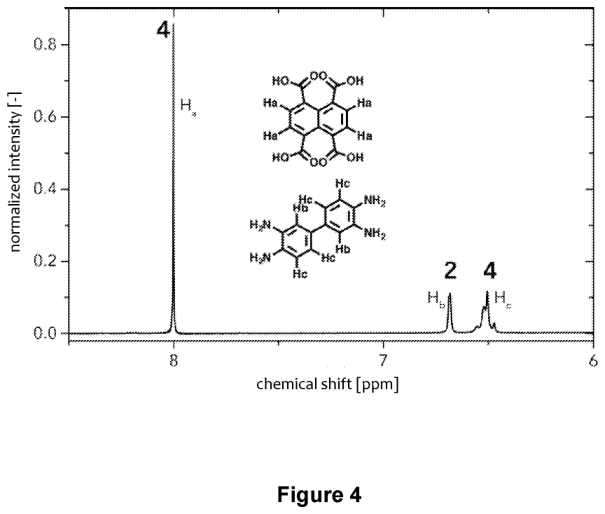

The NTCA (3.75 mmol, 1 eq.) obtained in Synthesis Example 1 was suspended in 750 ml of distilled H₂O and ice-cooled while the suspension was degassed with Ar for 10 min. 0.8035 g of 3,3′-diaminobenzidine (DAB) (3.75 mmol, 1 eq.) were added to the cold degassed suspension and stirred overnight, while temperature was slowly increased to room temperature. This yielded a light brown suspension. The solid formed was filtered off, thoroughly washed with H₂O and then EtOH and dried in an exsiccator. FIGS. 3 and 4 show the FTIR-ATR and ¹H NMR spectra of the obtained stoichiometric salt, NTCA.DAB. The IR spectrum differs greatly from the two educts NTCA and DAB and additionally contains the following characteristic bands: v(NH₂)=3375 cm⁻¹ and 3220 cm⁻¹, v(NH₃⁺)=2885 cm⁻¹ and 2585 cm⁻¹, v(C═O, carboxylate)=1505 cm⁻¹ and v(C═O, carboxylic acid)=1710 cm⁻¹. In the ¹H NMR spectrum, a DAB:NTCA molar ratio of 1:1 is clearly visible from the integral.

### Example 2—Step b) of the Method According to the Invention

### Hydrothermal Polymerization to Give a Polybenzimidazole of Formula (1)

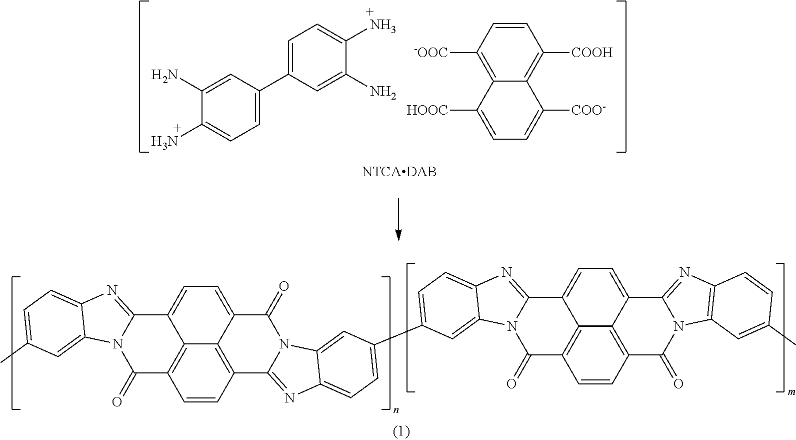

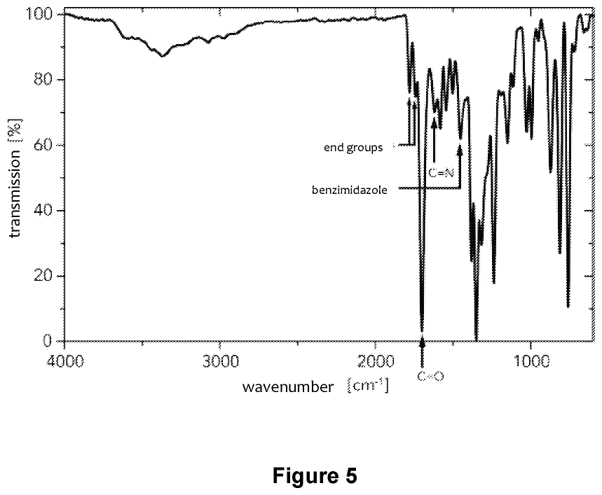

In a glass liner, 150 mg of NTCA.DAB were thoroughly suspended in 40 ml of distilled H₂O. The liner was transferred into a microwave autoclave (120 ml). Next, the reaction mixture was heated to 250° C. within 15 min while stirring and this temperature was maintained for another 15 min. Subsequent cooling was carried out by means of a stream of pressurized air and took about 30 min. The deep black suspension obtained after opening of the autoclave was filtrated, and a black solid and a clear liquid were obtained. The solid was thoroughly washed using distilled H₂O and then EtOH and dried at 80° C. in a vacuum drying oven. The FTIR-ATR spectrum of the solid is shown in FIG. 5 and confirms that this is the desired polybenzimidazole (1). The characteristic bands are: v(C═O)=1700 cm⁻¹, v(C═N)=1615 cm⁻¹ and v(benzimidazole)=1450 cm⁻¹. Furthermore, additional intensive bands at 1780 cm⁻¹ and 1740 cm⁻¹ are present, which, according to literature, indicates the presence of reactive terminal anhydride groups. The distinct visibility of these terminal group bands is indicative of a relatively low molecular weight of the polybenzimidazole (1).

Extraction of samples of the polybenzimidazole of formula (1) using various organic solvents (MeOH, EtOH, iPrOH, phenol, PE, EE, CDCl₂, CDCl₃, acetone, acetonitrile) each yielded clear filtrates not containing any impurities. Closer examination of the aqueous phase after hydrothermal polymerization showed that it did not contain any by-products of the hydrothermal polymerization, either.

### Example 3—Step b) of the Method According to the Invention

### Hydrothermal Polymerization to Give a Polybenzimidazole of Formula (1)

In a glass liner, 130 mg of NTCA.DAB were thoroughly suspended in 25 ml of distilled H₂O. The liner was transferred into a non-stirred batch steel autoclave (80 ml). Next, the reaction mixture was heated as quickly as possible to 250° C. without stirring in an external heating furnace (duration: about 45 min) and this temperature was maintained for another 15 min (total reaction time: 60 min). Then, the steel autoclave was cooled off by quenching using cold tap water. The deep black suspension obtained after opening of the autoclave was filtrated, and a black solid and a clear liquid were obtained. The solid was thoroughly washed using distilled H₂O and then EtOH and dried at 80° C. in a vacuum drying oven. In the FTIR-ATR spectrum of the solid, once again there were intensive bands of reactive terminal anhydride groups at 1780 cm⁻¹ and 1740 cm⁻¹ besides the characteristic polybenzimidazole bands at 1700 cm⁻¹, 1615 cm⁻¹ and 1450 cm⁻¹, which implies that, again, only a relatively low molecular weight was achieved despite the longer reaction time.

Again, extraction attempts of the polybenzimidazole of formula (1) and examinations of the aqueous phase after hydrothermal polymerization did not yield any results.

### Example 4—Step b) of the Method According to the Invention

### Hydrothermal Polymerization to Give a Polybenzimidazole of Formula (1)

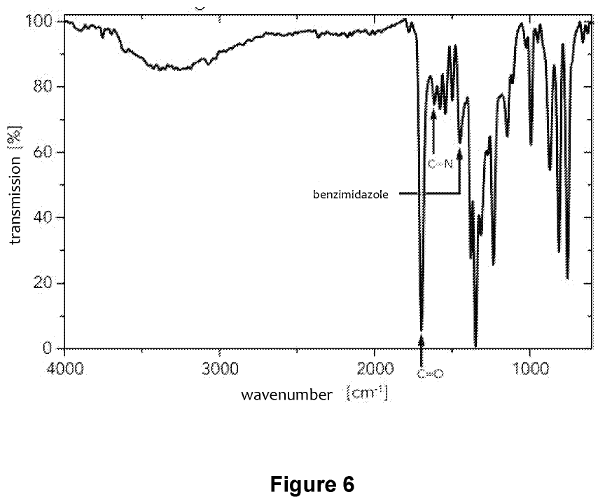

In a glass liner, 130 mg of NTCA.DAB were thoroughly suspended in 25 ml of distilled H₂O. The liner was transferred into a non-stirred batch steel autoclave (80 ml), which was pressurized at a pressure of 10 bar using argon. Next, the reaction mixture was heated as quickly as possible to 300° C. without stirring in an external heating furnace (duration: about 60 min) and this temperature was maintained for another 60 min (total reaction time: 120 min). Then the steel autoclave was cooled off by quenching using cold tap water. The deep black suspension obtained after opening of the autoclave was filtrated, and a black solid and a clear liquid were obtained. The solid formed was thoroughly washed using distilled H₂O and then EtOH and dried at 80° C. in a vacuum drying oven. The FTIR-ATR spectrum of the solid is shown in FIG. 6. Only very faint bands of reactive terminal anhydride groups were detectable besides the characteristic polybenzimidazole bands. The significantly reduced intensity of these bands as compared to Examples 2 and 3 is indicative of a significantly higher molecular weight.

Again, extraction attempts of the polybenzimidazole of formula (1) and examinations of the aqueous phase after hydrothermal polymerization did not yield any results.

### Example 5—Step b) of the Method According to the Invention

### Hydrothermal Polymerization to Give a Polybenzimidazole of Formula (1)

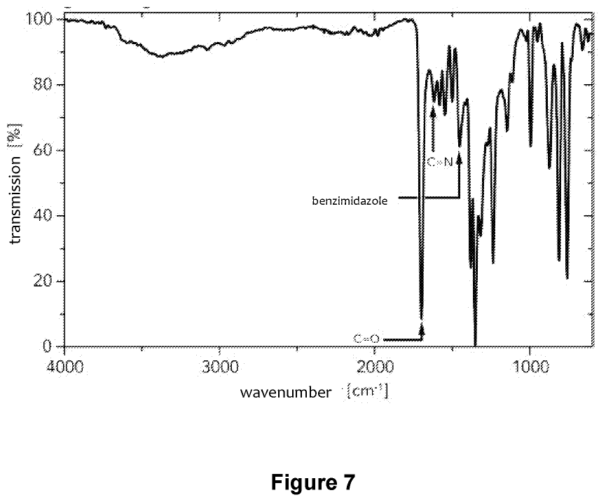

Example 4 was substantially repeated, with the exception that the reaction mixture was heated to a temperature of 350° C. within 90 min and the temperature was maintained for another 30 min. Like in Example 4, a black solid was obtained, the FTIR-ATR spectrum of which is shown in FIG. 7. In this case, no bands of reactive terminal anhydride groups at all were detectable besides the characteristic polybenzimidazole bands, which suggests a relatively high molecular weight of the polybenzimidazole of formula (1) obtained.

Extraction attempts of the polybenzimidazole of formula (1) and examinations of the aqueous phase after hydrothermal polymerization did not yield any results.

### Example 6—Step b) of the Method According to the Invention

### Hydrothermal Polymerization to Give a Polybenzimidazole of Formula (1)

Example 4 was substantially repeated, with the exception that the temperature of the reaction mixture was maintained at 300° C., not for 1 h, but for 11 h, so that the total reaction time amounted to 12 h. Again, the FTIR-ATR spectrum of the isolated black solid showed no bands of reactive terminal anhydride groups besides the characteristic polybenzimidazole bands, which is again indicative of a relatively high molecular weight of the polybenzimidazole of formula (1) obtained.

Extraction attempts of the polybenzimidazole of formula (1) and examinations of the aqueous phase after hydrothermal polymerization did not yield any results.

### Example 7—Step a) of the Method According to the Invention

### Preparation of a monomer salt from pyromellitic acid and DAB

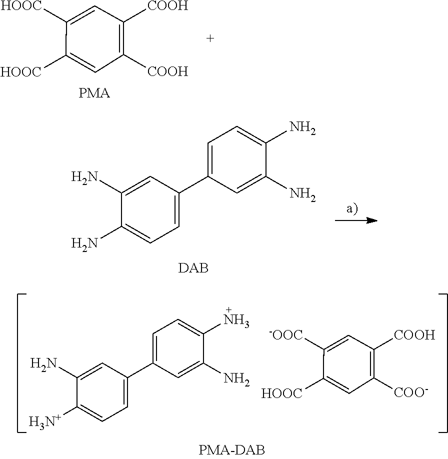

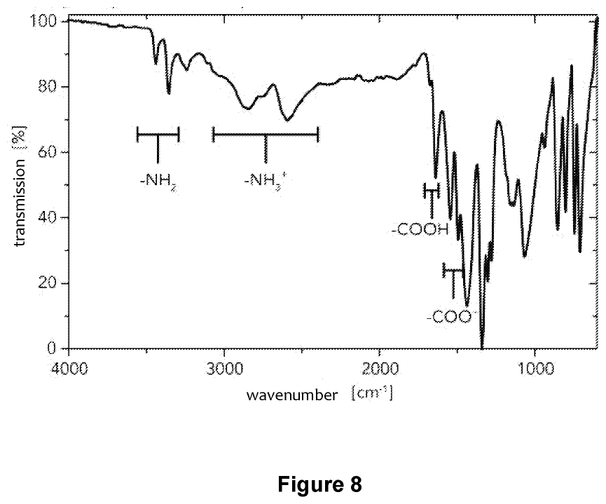

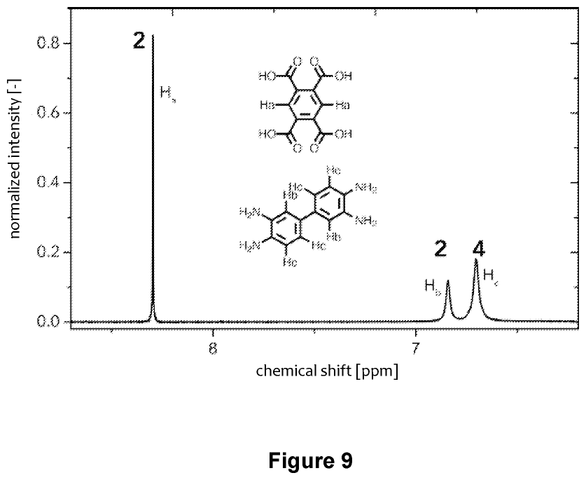

For the preparation of a stoichiometric salt, 0.9531 g of pyromellitic acid (PMA) (3.75 mmol, 1 eq.) were dissolved in 750 ml of distilled H₂O and ice-cooled while the solution was degassed using Ar for 10 min. 0.8035 g of 3,3′-diaminobenzidine (DAB) (3.75 mmol, 1 eq.) were added to the cold degassed suspension and stirred overnight, while the temperature was slowly increased to room temperature. This yielded a red suspension. The solid formed was filtered off, thoroughly washed using H₂O and then EtOH and dried in an exsiccator. FIGS. 8 and 9 show the FTIR-ATR and ¹H NMR spectra, respectively, of the stoichiometric salt PMA.DAB obtained. The IR spectrum differs greatly from the two educts PMA and DAB and additionally contains the following characteristic bands: v(NH₂)=3435 cm⁻¹ and 3355 cm⁻¹, v(NH₃⁺)=2885 cm⁻¹ and 2600 cm⁻¹, v(C═O, carboxylate)=1500 cm⁻¹ and v(C═O, carboxylic acid)=1685 cm⁻¹. In the ¹H NMR spectrum, a DAB:PMA molar ratio of 1:1 is clearly visible from the integral.

### Example 8—Step b) of the Method According to the Invention

### Hydrothermal Polymerization to Give a Mixture of a Polybenzimidazole of Formula (2) and an Intermediate of Formula (3)

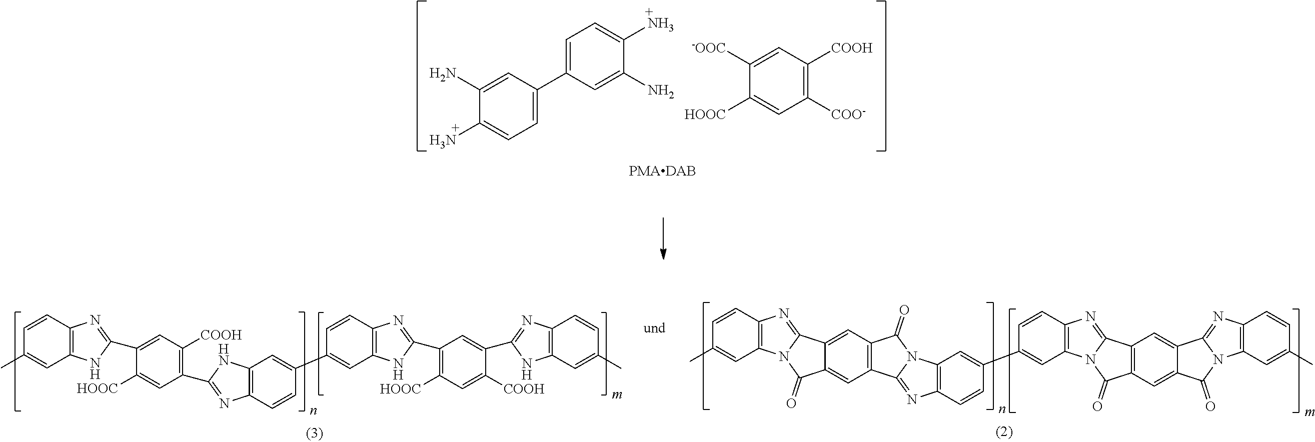

As in the reaction of Example 2, 150 mg of PMA.DAB were thoroughly suspended in 40 ml of distilled H₂O in a glass liner. The liner was transferred into a microwave autoclave (120 ml). Next, the reaction mixture was heated to 250° C. within 15 min while stirring and this temperature was maintained for another 15 min. Subsequent cooling was carried out by means of a stream of pressurized air and took about 30 min. The orange suspension obtained after opening the autoclave was filtrated, and an orange solid and a clear liquid were obtained. The solid was thoroughly washed using distilled H₂O and then EtOH and dried at 80° C. in a vacuum drying oven. The FTIR-ATR spectrum of the solid confirms that this is a mixture of the desired polybenzimidazole (2) and an intermediate of formula (3) with free carboxyl groups. The characteristic bands are: v(C═N/C═C)=1630 cm⁻¹, v(ring vibration)=1585 cm⁻¹ (characteristic for the conjugation between the benzene and the imidazole ring), and v(benzimidazole)=1445 cm⁻¹. However, a band v(C═O)=1760 cm⁻¹ characteristic for the entirely cyclized product is barely detectable, which suggests that mainly the intermediate of formula (3) was formed.

### Example 9—Step c) of the Method According to the Invention

### Solvent-Free Thermal Treatment

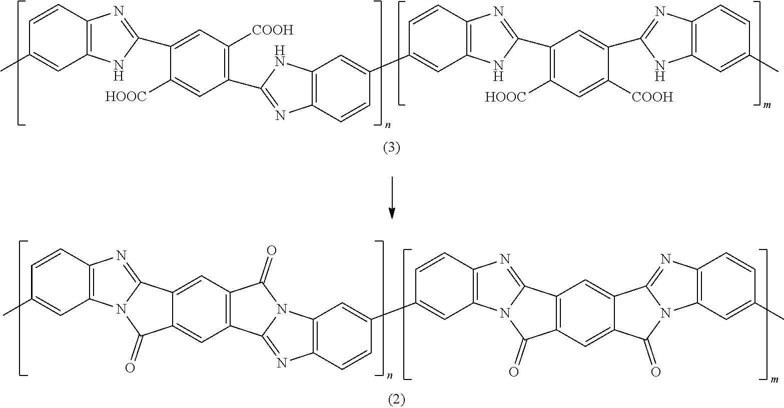

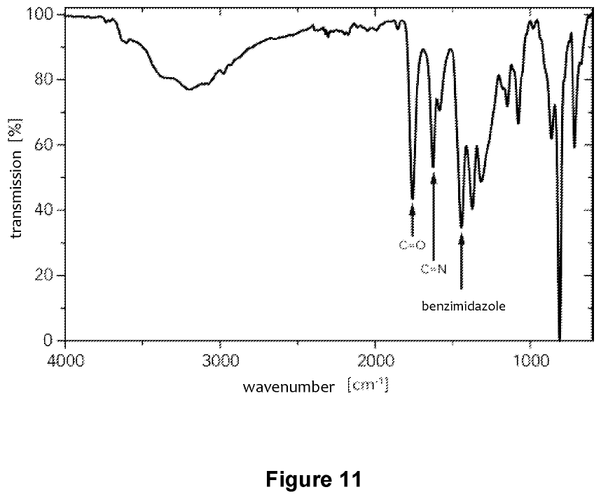

The orange solid isolated in Example 8 was subjected to a solvent-free thermal treatment at 400° C. (30 min holding period) in order to effectuate entire cyclization and convert the intermediate of formula (3) into the polybenzimidazole of formula (2). FIG. 11 shows the FTIR-ATR spectrum of the dark brown solid thus obtained, which shows that no free carboxyl groups were present anymore, but that the C═O bands at 1760 cm⁻¹ were now especially pronounced: v(C═O)=1760 cm⁻¹, v(C═N)=1620 cm⁻¹ and v(benzimidazole)=1440 cm⁻¹.

Extraction attempts with the polybenzimidazole of formula (2) analogous to those for the one of formula (1) and examinations of the aqueous phase after hydrothermal polymerization did not yield any results, so in this case, no by-products were formed either.

### Example 10—Step b) of the Method According to the Invention

### Hydrothermal Polymerization to Give a Mixture of a Polybenzimidazole of Formula (2) and an Intermediate of Formula (3)

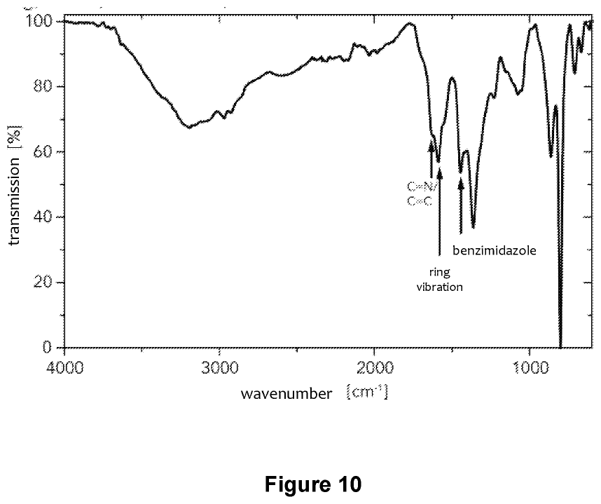

In a glass liner, 130 mg of PMA.DAB were thoroughly suspended in 25 ml of distilled H₂O. The liner was transferred into a non-stirred batch steel autoclave (80 ml), which was pressurized at a pressure of 10 bar using argon. Then, the reaction mixture was heated as quickly as possible to 275° C. without stirring in an external heating furnace (duration: about 60 min) and this temperature was maintained for another 60 min (total reaction time: 120 min). Then the steel autoclave was cooled off by quenching using cold tap water. The brown suspension obtained after opening of the autoclave was filtrated, and a brown solid and a clear liquid were obtained. The solid was thoroughly washed using distilled H₂O and then EtOH and dried at 80° C. in a vacuum drying oven. The FTIR-ATR spectrum of this solid was almost identical to the one in FIG. 10, but with a somewhat stronger C═O band at 1760 cm⁻¹, which suggests a higher proportion of already cyclized polybenzimidazole of formula (2).

### Example 11—Step c) of the Method According to the Invention

### Solvent-Free Thermal Treatment

Thermal treatment of the brown solid in an analogous manner to Example 9 yielded a dark brown solid, the FTIR-ATR spectrum of which was substantially identical to the one in FIG. 11 and which shows entire cyclization to a polybenzimidazole of formula (2).

Extraction attempts of the polybenzimidazole of formula (2) and examinations of the aqueous phase after hydrothermal polymerization did not yield any results.

### Example 12—Step b) of the Method According to the Invention

### Direct Polycondensation of PMA.DAB to Give a Polybenzimidazole of Formula (2)

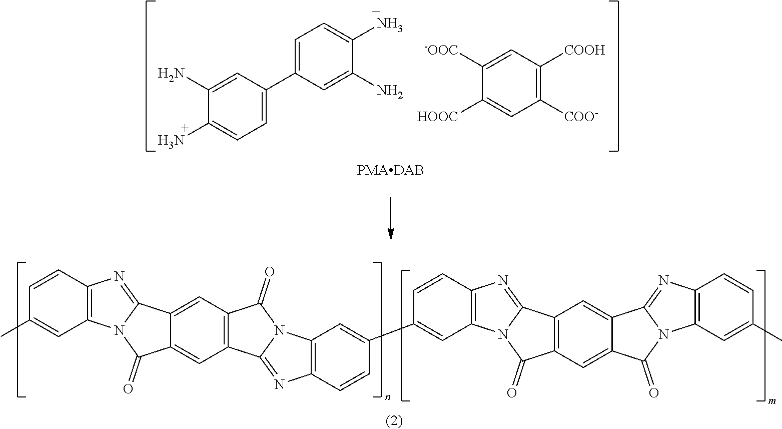

Example 10 was substantially repeated, using 130 mg of PMA.DAB in 25 ml of distilled H₂O, with the exception that the reaction mixture was heated to a temperature of 350° C. within 90 min and the temperature was maintained for another 90 min. The brown suspension obtained after opening of the autoclave was filtrated, and a dark brown solid and a clear liquid were obtained. The solid was thoroughly washed using distilled H₂O and then EtOH and dried at 80° C. in a vacuum drying oven. The FTIR-ATR spectrum of this solid was practically identical to the one in FIG. 11, which suggests that, in this case, only an entirely cyclized polybenzimidazole of formula (2) and substantially no intermediate of formula (3) was formed.

Once more, extraction attempts of the polybenzimidazole of formula (2) and examinations of the aqueous phase after hydrothermal polymerization did not yield any results.

1. A method for preparing polybenzimidazoles of formula (1) or (2) below, wherein n and m are each ≥1: 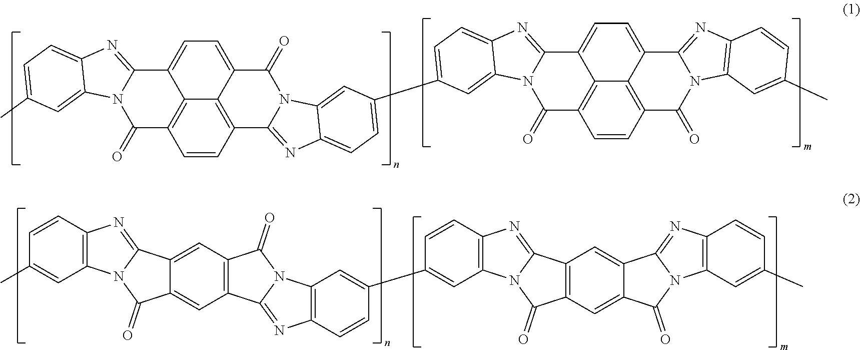
by polycondensation of corresponding tetracarboxylic acids or dianhydrides and tetraamines by jointly heating the reactants,
characterized in that
the preparation of polybenzimidazoles of formula (1) or (2) is carried out by using tetracarboxylic acids as starting material and substantially without the formation of any by-products, wherein
a) first, a stoichiometric salt is formed from the tetracarboxylic acid and the tetraamine;
b) polycondensation is carried out under hydrothermal conditions by heating the stoichiometric salt obtained in step a), in water as a solvent and under pressure, to temperatures above 100° C.,
wherein the values of n and m and, thus, the molecular weight and/or the extent of cyclization in the polycondensate obtained, are/is regulated by means of the temperature and/or the duration of the polycondensation; and
c) optionally, a solvent-free thermal treatment of the polycondensate is carried out in order to achieve complete cyclization.

2. The method according to claim 1, characterized in that a polybenzimidazole of formula (1) is prepared according to the reaction scheme below, wherein
in step a), naphthalene tetracarboxylic acid (NTCA) is reacted with diaminobenzidine (DAB) to form the stoichiometric salt NTCA.DAB which
in step b), is polycondensed under hydrothermal conditions to form the polybenzimidazole of formula (1):

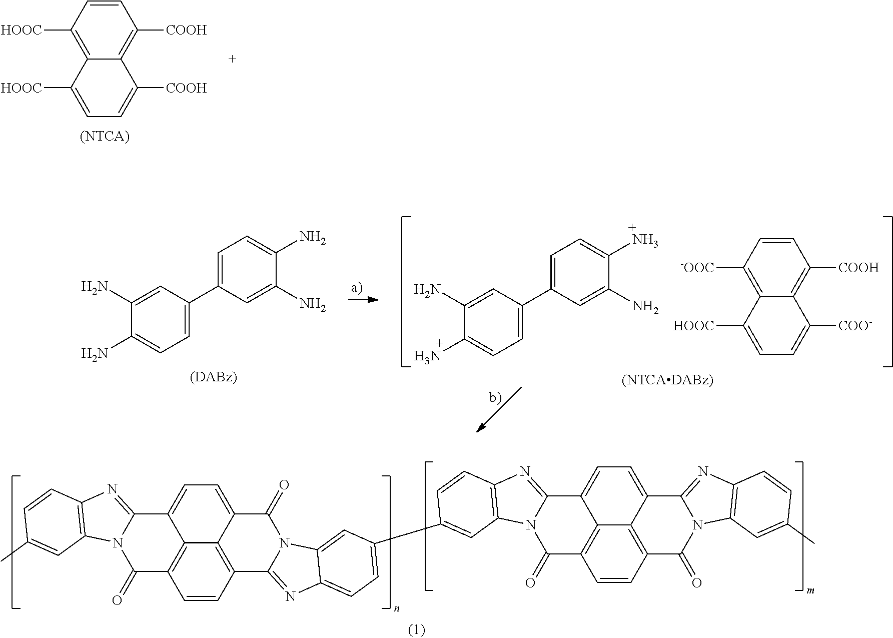

3. The method according to claim 2, characterized in that the polycondensation in step b) is carried out at a temperature of not more than 250° C. and/or for a duration of not more than 1 h in order to produce a polybenzimidazole (1) having a relatively low molecular weight.

4. The method according to claim 2, characterized in that the polycondensation in step b) is carried out at a temperature of not more than 300° C. and/or for a duration of not more than 2 h in order to produce a polybenzimidazole (1) having a medium molecular weight.

5. The method according to claim 2, characterized in that the polycondensation in step b) is carried out at a temperature above 300° C. and/or for a duration of at least 2 h in order to produce a polybenzimidazole (1) having a relatively high molecular weight.

6. The method according to claim 1, characterized in that a polybenzimidazole of formula (2) is prepared according to the reaction scheme below, wherein
in step a), pyromellitic acid (PMA) is reacted with diaminobenzidine (DAB) to form the stoichiometric salt PMA.DAB which
in step b), is polycondensed under hydrothermal conditions to form a non-cyclized or partially cyclized intermediate (3) and/or the polybenzimidazole of formula (2): 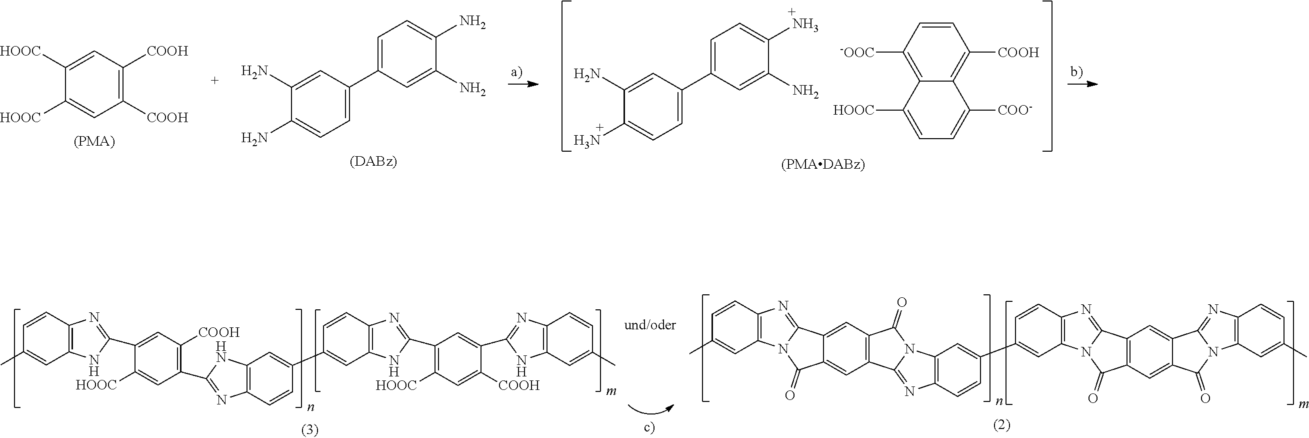
whereafter, optionally, step c) is carried out in order to convert the intermediate (3) completely into the polybenzimidazole of formula (2).

7. The method according to claim 6, characterized in that the polycondensation in step b) is carried out at a temperature of not more than 250° C. and/or for a duration of not more than 1 h in order to substantially produce only the intermediate (3) which, in the subsequent step c), is cyclized to form the polybenzimidazole (2).

8. The method according to claim 6, characterized in that the polycondensation in step b) is carried out at a temperature of not more than 275° C. and/or for a duration of not more than 2 h in order to produce a mixture of the polybenzimidazole (2) and the intermediate (3) which, in the subsequent step c), is fully cyclized to form the polybenzimidazole (2).

9. The method according to claim 6, characterized in that the polycondensation in step b) is carried out at a temperature of at least 350° C. and/or for a duration of at least 2 h in order to substantially produce only the polybenzimidazole (2).

10. The method according to claim 6, characterized in that the solvent-free thermal treatment in step c) is carried out at a temperature of at least 200° C., preferably at least 300° C., more preferred about 400° C.

11. The method according to claim 7, characterized in that the solvent-free thermal treatment in step c) is carried out at a temperature of at least 200° C., preferably at least 300° C., more preferred about 400° C.

12. The method according to claim 8, characterized in that the solvent-free thermal treatment in step c) is carried out at a temperature of at least 200° C., preferably at least 300° C., more preferred about 400° C.
